(19) United States
(12) Patent Application Publication
(10) Pub. No.: US 2018/0365662 A1
(43) Pub. Date: Dec. 20, 2018

(54) SYSTEM AND METHOD TO PROTECT A PURCHASER'S ACCOUNT INFORMATION DURING AN ELECTRONIC TRANSACTION

(71) Applicants: Alexandre GONTHIER, Emerald, CA (US); Mario Delas, Englewood, CO (US); Michael Kontorovich, Maroubra (AU)

(72) Inventors: Alexandre GONTHIER, Emerald, CA (US); Mario Delas, Englewood, CO (US); Michael Kontorovich, Maroubra (AU)

(73) Assignee: PayWithMyBank, Inc., Redwood City, CA (US)

(21) Appl. No.: 16/108,860

(22) Filed: Aug. 22, 2018

Related U.S. Application Data
(63) Continuation of application No. 13/803,447, filed on Mar. 14, 2013, now abandoned.
(60) Provisional application No. 61/677,150, filed on Jul. 30, 2012.

(51) Int. Cl. G06Q 20/10; G06Q 20/40; G06Q 20/22; G06Q 20/12; G06Q 20/02

(52) U.S. Cl. CPC G06Q 20/10; G06Q 20/4012; G06Q 20/227; G06Q 20/108; G06Q 20/12; G06Q 20/027

(57) ABSTRACT

An electronic transaction system interacts directly with the purchaser's bank accounts to effect funds transfers from a purchaser's bank account to a vendor's bank account. The system receives an identification of the vendor, and the amount to be transferred, and proceeds to prompt the purchaser for the purchaser's bank access information. The system accesses the purchaser's banking system, and displays the balances in the purchaser's accounts. The purchaser selects the appropriate account, and the transaction system executes an electronic transfer request to transfer the funds from the selected account to the vendor's bank account and provides a payment confirmation to the vendor. Throughout this process, the vendor has no access to the purchaser's banking information.

This application is a Continuation of U.S. patent application Ser. No. 13/803,447, filed 14 Mar. 2013, and claims the benefit of U.S. Provisional Patent Application 61/677,150, filed 30 Jul. 2012.

### BACKGROUND AND SUMMARY OF THE INVENTION

This invention relates to the field of electronic financial transaction systems, and in particular to a system that effects the transfer of funds from a user's bank account to a vendor's bank account without disclosing any user bank account information to the vendor.

The use of the Internet to purchase goods and services from a vendor continues to increase. In a conventional electronic transaction system, the vendor receives payment via a deposit of funds into a bank account of the vendor by a credit card service, or via a financial transaction service, such as PayPal. A corresponding debit is applied to an account of the purchaser at their credit card provider, or their financial transaction provider, or their bank or other financial institution. In many cases, the financial transaction provider executes the transaction by charging a credit card account associated with the purchaser.

Many potential customers, however, are reluctant to use credit cards for a variety of reasons. It is very easy to overspend, because the credit card user may not be aware of the cumulative amount being charged during the credit card cycle period (also known as balance), or because the credit card user is reacting impulsively to a particular vendor's offer, without a cognizant recognition of the consequences of the purchase.

Other potential customers may be reluctant to communicate their credit card information over the Internet, for fear of identity theft by a third party breaking into the vendor's systems, or lack of trust in a new and virtually unknown vendor. Also, some customers may simply not have time or interest to register and create a new payment account at a non-credit card transaction system.

Many vendors reluctantly accept credit card transactions as a necessity for operating a viable online business. Credit card providers may charge a vendor three percent or more of the transaction amount, and there may be a delay of weeks or even months before the funds are credited to the vendor.

The overhead associated with managing customer and vendor accounts in a credit card network or financial transaction providers that rely on credit cards (such as PayPal) can be substantial. The credit card service providers in the network must maintain an ongoing account for each customer and each vendor, must process transactions in real-time over an electronic network, must provide monthly statements to customers and comply to various federal and state regulations regarding these statements and other operating rules, must provide frequent deposits to vendor accounts, typically daily, must manage dispute resolution, and may have to absorb the cost of fraudulent transactions. These services account for a substantial portion of the fees that are charged to the vendors.

It would be advantageous to allow purchasers to pay online without needing a credit card or other new payment account. It would be advantageous to reduce the transaction costs and delays associated with online purchases. It would be advantageous to provide an alternative to credit card transactions.

These advantages, and others, can be realized by a system that interacts directly with the purchaser's existing bank accounts to effect funds transfers from the purchaser's bank account directly to the vendor's bank account. The system is enabled when the purchaser selects this payment option on the vendor's website. The system receives an identification of the vendor, and the amount to be transferred, and proceeds to prompt the purchaser for the purchaser's bank access information. With this information, the system accesses the purchaser's bank account(s), displays the purchaser's bank accounts and balances, and enables those accounts that have sufficient funds to cover the purchase amount for the contemplated transaction. When the purchaser selects the appropriate enabled account, an electronic transfer request is generated to effect the transfer from the purchaser's selected account to the vendor's bank account without disclosing the purchaser's account information to the vendor. The provider of the transaction system does not maintain financial accounts for either the purchaser or the vendor; the provider relies on transfers between the purchaser's and vendor's existing bank accounts and thus the overhead required to operate this transaction system is minimal.

### BRIEF DESCRIPTION OF THE DRAWINGS

The invention is explained in further detail, and by way of example, with reference to the accompanying drawings wherein:

FIG. 1 illustrates an example network that includes a transaction system that interfaces with a purchaser, a vendor system, and an online bank in accordance with aspects of this invention.

FIG. 2 illustrates an example flow diagram of the operation of a transaction system in accordance with aspects this invention.

FIG. 3 illustrates an example block diagram of a transaction system in accordance with aspects this invention.

FIGS. 4A-4F illustrate example screen shots of a user interface to an example embodiment of a transaction system in accordance with aspects of this invention. Throughout the drawings, the same reference numerals indicate similar or corresponding features or functions. The drawings are included for illustrative purposes and are not intended to limit the scope of the invention.

FIG. 5 illustrates an example flow diagram of an example interactive user interface.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

In the subsequent disclosure, for ease of presentation and understanding, terms such as ‘purchaser’, ‘vendor’, and ‘bank’ are used as generic identifiers for the parties of a transaction that includes a transfer of funds or other resources from an account of one party to an account of another party. The term ‘bank’, for example, includes any depository having funds in an account associated with the ‘purchaser’; the ‘purchaser’ includes any party having an account at the bank from which the funds are to be debited; and the ‘vendor’ includes any party having an account to which the funds are to be credited, without regard to the particular depository that provides the vendor's account. In like manner, the terms ‘account’, ‘account number’, ‘routing number’, and the like are to be interpreted in their most generic form.

Also for ease of presentation and understanding, the disclosed system is presented in the context of a transaction system for transferring funds from a bank account to another bank account. Terms such as Automated Clearing House (ACH), Open Financial Exchange (OFX), and the like are also to be interpreted in a generic sense, to include systems and formats of similar functionality in the United States and other nations.

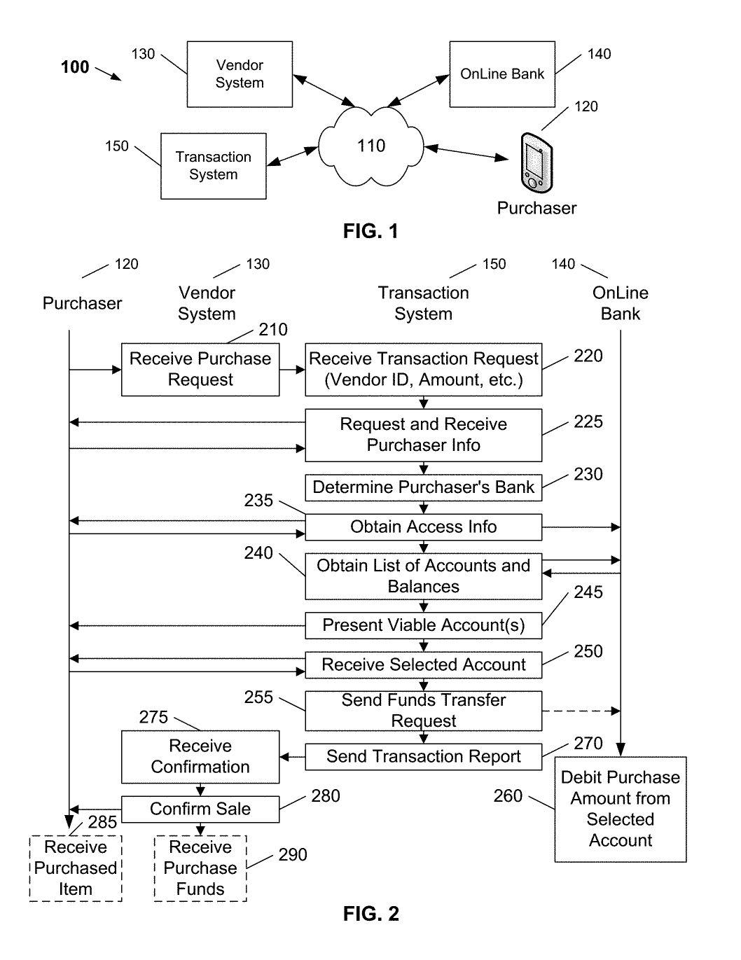

FIG. 1 illustrates an example network 100 that includes a transaction system 150 that interfaces with a purchaser 120, a vendor system 130, and an online bank 140. In this example, each of the elements 120-150 communicates with the other elements via a common communication network 110, such as the Internet. For ease of presentation and understanding, the invention is presented herein using the paradigm of elements 120-150 operating on the Internet, including, for example, communicating via a web-browser. One of skill in the art will recognize, however, that the principles of this invention are not limited to the use of a common network among all of the elements, and multiple networks may be used, depending upon the particular means used to communicate with each of the systems 120, 130, 140.

In like manner, although the elements 120-150 are illustrated as singular entities, one of skill in the art will recognize that one or more of these elements 120-150 may include a “distributed system”, wherein different tasks may be performed by different elements. Similarly, the term ‘program’ as used herein may include multiple executable modules, each module performing one or more of the tasks associated with the program.

The operation of the transaction system 150 in the network 100 of FIG. 1 may best be understood with reference to the example flow diagram of FIG. 2.

After browsing pages on a vendor's website, the purchaser 120 may decide to purchase an item offered by the vendor, and will express that decision via ‘clicks’ or other actions that will result 210 in a purchase request being received at the vendor system 130. This purchase request may include an identification of the item being purchased, a purchase price, an identifier of the purchaser, and so on.

Upon receipt 210 of this purchase request, the vendor system 130 may send a transaction request to the transaction system 150; the transaction request will generally include at least an identifier of the vendor and the amount to be transferred to the vendor to satisfy this request. In a preferred embodiment of this invention, only ‘pre-approved’ (vetted) vendors are permitted to use this transaction system, and the transaction system includes a database that provides an identification of the account of the vendor to which the purchase amount is to be deposited. Alternatively, in a non-vetted system, the transaction request includes the identification of the vendor's account.

Upon receipt 220 of the transaction request, control of the process passes to the transaction system 150 for obtaining further information from the purchaser. Of particular note, the transaction system 150 obtains sufficient information for determining 230 a bank that is associated with the purchaser. The information may be obtained, for example, by prompting the purchaser for the “Routing Transit Number” (RTN) of the bank, or by presenting the purchaser the option of choosing the bank from a list of bank names or logos.

Having determined the purchaser's bank, the transaction system may access the bank's online system to determine the information required for accessing the purchaser's account(s). This information may include the requirement for a username, an access code, a password, a PIN, etc., depending upon the particular bank. The identification of the information (not the information itself for particular users) required for a particular bank is preferably stored in a database at the transaction system, so that subsequent interactions with this bank may avoid having to determine what information the bank requires for accessing a user's account.

The transaction system obtains the access information from the purchaser at 235, by prompting the purchaser for the required information elements. Alternatively, the transaction system may be configured to serve as a ‘pass-through’ element, wherein the transaction system presents a copy of the bank's login page(s) to the purchaser, and forwards the purchaser's responses to the bank. An advantage of the former approach is that a substantially uniform user interface may be provided by the transaction system, regardless of the particular bank. An advantage of the latter approach is that it provides a familiar interface to users of that particular bank's online service. With either approach, the system effects the transaction without sending (i.e. re-directing) the purchaser to their bank's actual online service.

Preferably, in a first example embodiment of this invention, the transaction system is configured to obtain the minimum access information required to obtain an identification of each account associated with the purchaser at this bank, and the current balance in each account. For example, some banks, such as Bank of America, ING Direct, and others, support the use of an “access code” that provides read-only access to the user's accounts, and a different “password” that provides total control of the user's accounts, including transfers/withdrawals from each account. In this example first embodiment of the invention, the transaction system identifies the access code as the information required from the purchaser, rather than the password.

Having obtained access to the user's online account at the bank (i.e. the user has logged in), the transaction system obtains 240 an identification of each of the user's bank accounts, and the current balance in each account.

If the initial access to the list of a user's bank accounts and balances does not provide a unique identifier of each of the purchaser's accounts (e.g. the specific account number and routing number), the transaction system will process the information provided on the bank's summary and/or detailed presentation of the purchaser's accounts to uniquely identify each of the user's bank accounts. For example, if the presented summary information only includes the “last four” digits of a given account number, the transaction system will initiate a search for prior “online statements” for said account. Such statements are typically provided in “.pdf” files within the purchaser's data files accessible within the bank's online system.

Alternatively, the transaction system may search such pages as a “my accounts” page, a “my account information” page, a “nicknames” page, or the like to obtain the complete information required to uniquely identify each of the purchaser's accounts. Also alternatively, if the information is not easily obtainable from the bank, the purchaser may be prompted to provide the account number and/or the routing number, directly or via an indirect, related question (for example, an account location prompt which allows to determine the routing number).

In a preferred embodiment of this invention, accounts that have a sufficient balance to cover the cost of purchasing the item from the vendor are identified as ‘viable’ accounts to support the transaction, and the current balance in each is presented 245 to the purchaser. The non-viable accounts and their current balances may also be presented, but typically in a “greyed” format, indicating that these accounts are not available for use in the current transaction.

The purchaser is then provided the option of selecting an account to use for executing the purchase. Of particular note, the presentation of each of the user's accounts allows the user to consider which one of their various bank accounts to use with the purchase. In addition, the presentation of the balance in each of the user's accounts allows the user to reconsider whether to continue with the purchase; in like manner, because the system allows to only enable the user to select an account with sufficient funds to cover the purchase, the user's decision to continue the purchase process provides substantial assurance at that time that the vendor will receive payment for the purchase.

When the user identifies 250 the selected account for fulfilling the purchase, the transaction system uses the selected account's unique identifier required to effect a funds transfer of the purchase amount from the selected account.

One of skill in the art will recognize that if the aforementioned search of prior statements and the like is required to obtain the unique identifier associated with each of the user's accounts, this searching may be postponed until after the user selects a particular account, thereby avoiding having to find each account's unique identifier. ed, at 240.

Optionally, the transaction system may be configured to include a “purchaser” database, which may include the aforementioned bank access information, as well as the account numbers associated with each of the purchaser's accounts. By maintaining such a database, after the first transaction with the purchaser, the search for this information may be avoided by merely accessing this database. In a preferred embodiment, at least one element of the purchaser's required access information will not be stored in the purchaser database, so that each transaction will require the potential purchaser to provide the missing information. This precaution also protects the purchasers that use this transaction system in the event that the stored purchaser information is accessed/‘hacked’ by an unauthorized third party.

Given the identifier of the purchaser's selected (and viable) bank account, the identification of the vendor's account, and the purchase amount, the transaction system generates 255 a funds transfer request to transfer the purchase amount from the purchaser's selected account to the vendor's account. The funds transfer request is illustrated as a dashed arrow to the bank, because the particular form of the funds transfer request will be dependent upon the processes available for effecting such a transfer, which may or may not include a direct communication between the transaction system 150 and the bank 140.

The funds transfer may be effected, for example, by submitting the request within the Automated Clearing House (ACH) system if in the United States. The submission of an ACH funds transfer from one account to another will generally effect a debit to the purchaser's account and a corresponding credit to the vendor's account within 1 to 3 business days. In another embodiment of this invention, detailed further below, the funds transfer request is submitted to the bank, directly or via a 3^{rd}-party real-time payment network connected to the bank, and the bank effects the transfer to the vendor's account, directly or via said 3^{rd} party network. This alternative embodiment ensures that the funds are immediately debited from the purchaser's account at the time of the transaction, consistent with the availability of the ‘current’ balance in the account.

Upon satisfaction of the funds transfer request, the purchaser's selected account will be debited for the purchase amount 260, and the vendor's identified account will be credited for the purchase amount 290.

Upon submission of the funds transfer request, the transaction system sends 270 a transaction report to the vendor system. In a preferred embodiment, the transaction report will include a confirmation that the purchase amount is scheduled to be transferred to the vendor's account, but will not include an identification of the purchaser's bank account information, thereby protecting the purchaser from potential future unauthorized charges by persons with access to the vendor's records.

Upon receipt 275 of the transaction report, and assuming that the report indicates that the purchaser has authorized the transaction successfully, the vendor system may confirm 280 to the purchaser that the purchase was successfully authorized. At some time in the future, the purchaser will receive 285 the purchased item, and the vendor will receive 290 the purchase amount, thereby culminating the purchase agreement.

It is significant to note that the transaction system provider 150 does not receive or disperse any funds throughout the transaction process. Accordingly, the provider of the transaction system 150 is not subject to a variety of regulatory procedures associated with fiduciary matters, and has no responsibility for maintaining individual purchaser accounts, thereby avoiding a significant portion of the overhead associated with providers of credit card accounts and other financial transaction systems.

The transaction system 150, for example, need only maintain a record of each transaction, such as the transaction request from the vendor, and the purchaser's authorization of the transfer from the purchaser's select account, to facilitate resolution of disputed transactions by the transaction system 150.

In like manner, assuming that the provider of the transaction system imposes a fee on the vendors that use the transaction system, individual vendor activity records need only be maintained to facilitate the transaction reporting and billing and collection of the associated fees.

It is also significant to note that the provider of the transaction system will have in most cases obtained strong authentication of the purchaser from their bank and will therefore experience less fraud and only be peripherally involved in disputes between the purchaser and vendor, as contrast to the credit card service providers that experience fraud more frequently due to their weaker purchaser authentication procedures and as a result experience and must resolve disputes more frequently.

Accordingly, based on the above cited advantages and others, the overhead associated with providing the transaction system of this invention will be substantially less than that of providing a credit card, or other funds transfer transaction system, and the provider of the transaction system of this invention will be able to correspondingly impose substantially lower fees to vendors for use of the transaction system presented herein.

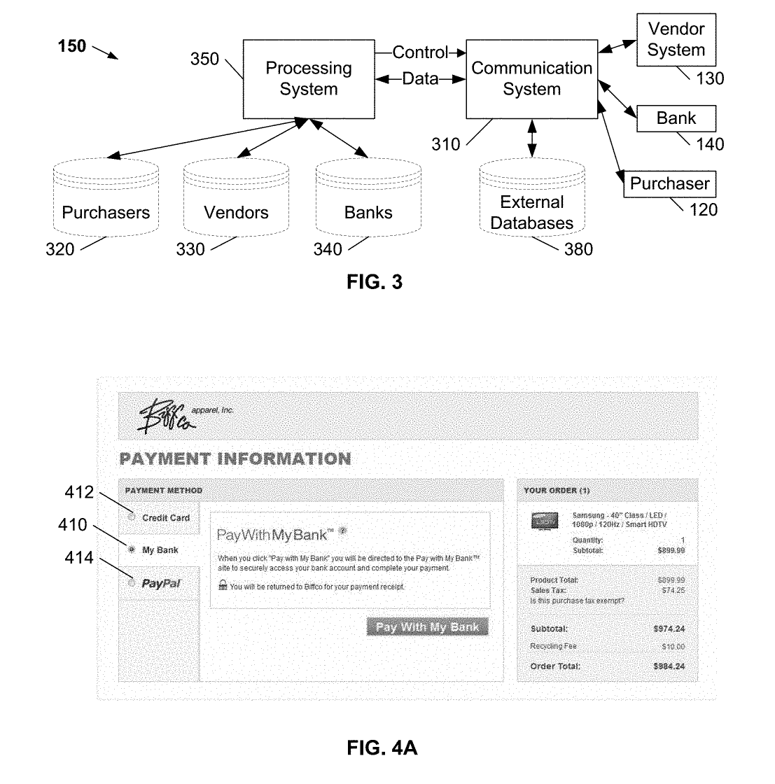

FIG. 3 illustrates an example block diagram of a transaction system 150 in accordance with aspects this invention.

The example transaction system 150 includes a processing system 350 and a communication system 310. Optionally, as detailed further below, the system 150 may include one or more databases 320, 330, 340.

The communication system 310 provides communication between the transaction system 150 and each of the other elements in the network 100 of FIG. 1, including the purchaser 120, the vendor system 130, and the bank 140, via the communication network 110. As noted above, the example communication network 110 may be the Internet, and the communications may be effected via interactions with web-pages and/or conventional messaging. Although illustrated as a single element, the communication system 310 may include a variety of communication devices, depending upon the particular means used to communicate with each of the particular elements 120, 130, 140, 320, 330, 340.

In particular, with regard to the example flow diagram of FIG. 2, the communication system 310 is configured to receive the transaction request from, and transmit the transaction report to, the vendor system 130. It is also configured to interact with the purchaser 120 to request and receive the information required to identify the purchaser's bank 140 and to gain access to the balance associated with each of the purchaser's accounts at the bank 140. The communication system 310 also presents these balances to the purchaser and receives the purchaser's selection of an account to be used for the transaction, if any. If the purchaser has agreed to continue the transaction by selecting an account to use, the communication system 310 is configured to communicate a funds transfer request to the bank 140.

The processing system 350 is configured to control the aforementioned communication sequences, to process the information received, and to create the information to be transmitted by the communication system 310. The processing system 350 is also configured to interact with the optional purchaser, vendor, and bank databases 320, 330, 340, respectively.

In particular, the processing system 350 is configured to process the transaction request that is received from the vendor system 130 to identify the purchase amount and an account associated with the vendor into which the purchase amount is to be transferred. In a preferred embodiment of this invention, the transaction system 150 includes a vendor database 330 that facilitates this processing. The vendor database may include, for example, for each vendor: a unique identifier of the vendor, an identifier of a bank account, security information, particular rules and criteria, and so on.

As noted above, in a preferred embodiment of the transaction system 150, each vendor is vetted before enabling the vendor to interact with the transaction system 150, and the data in the vendor database will generally be created when an agreement is reached between the provider of the transaction system 150 and the provider of the vendor system 130. The agreement will generally include an agreed transaction cost to the vendor, which may be a flat fee, a percentage of the purchase amount, or other arrangement. The agreement may also include the details required for creating an interface with the transaction system 150 to effect the receipt of the transaction request and the transfers of control between the vendor system 130 and the transaction system 150.

In a preferred embodiment, a portion of the transaction request may be encoded by the vendor system, and the aforementioned security information may be used to decode such portions. In like manner, the transaction request may be cryptographically signed by the vendor system, and the security information is used to validate that the request was received, unaltered, from the identified vendor system.

The vendor may also establish particular rules and criteria associated with transactions with the vendor's system, such as a requirement that transactions above a given purchase amount must be performed via a direct funds transfer request to the bank, and a corresponding confirmation must be received from the bank that the purchaser's account has been debited for the entire purchase amount.

The processing system 350 is also configured to control communications with the purchaser and process the information received in order to identify the bank associated with the purchaser. In a preferred embodiment of this invention, the transaction system 150 includes a bank database 340 that includes for example, for each bank: a name and address of the bank, the unique routing number, the type of information required to access a purchaser's records at the bank, security information, particular rules and criteria, and so on.

The type of information required to access a purchaser's records may be stored in the banks database 340 as a schema or a script that also indicates the order in which the access information must appear in the requests to the particular bank for access to the purchaser's records. For ease of reference, the term ‘access protocol’ is used hereinafter to identify the sequence and format of information required to access the purchaser's records, including a record of the balance available in each of the purchaser's accounts. As noted above, if the bank supports an access protocol that enables read-only access to the purchaser's accounts, the use of that access protocol may generally be preferred except as noted further below.

The security information in the banks database 340 may be, for example, a password that the bank establishes for the transaction system 150 to effect communications with the bank. For example, a particular bank may require that the provider of the transaction system 150 be vetted before the transaction system is permitted to perform some or all of the operations available within the bank's online system. In like manner, the bank may establish limits on the amount of money that may be transferred from a purchaser's account during a given time period, or may require additional security measures be enforced when the purchase amount exceeds a given threshold.

As noted above, the purchaser may identify the bank using the bank's unique routing number, or using the bank's name and location. Optionally, the purchaser may be provided the option of selecting the bank from a list of banks provided from the banks database 340. If the bank has multiple routing numbers, the purchaser may be asked for additional information, such as the state, city or specific branch in which the account was first opened.

If the purchaser's bank is not located in the banks database 340, the processing system 350 may be configured to prompt the user for the information required to identify the bank, such as the name and address of the bank and/or its routing number. This new information may be confirmed using commonly available external databases that provide such information, and, if it is confirmed, the processing system 350 may create a new bank record within the bank database 340.

In an embodiment of this invention, the processing system 310 is configured to automatically attempt to determine the type of information that is required to access a purchaser's records on a newly identified bank. If the bank is part of a data sharing network, such as the Open Financial Exchange (OFX), the protocol required to access a purchaser's account is pre-defined, and can be added to the bank record in the bank database 340 directly. Otherwise, the processing system 350 may be configured to search for the bank's online website, using, for example, Google or other search engine, then analyze the content of the website (e.g. html content) to determine fields that are provided for the user to enter access information.

While interacting with the purchaser that first identifies the new bank, the processing system 350 may use a trial-and-error approach to determine the appropriate access protocol for this new bank, and will store this protocol information in this bank's record in the banks database 340. Alternatively, the transaction system 150 may temporarily postpone the current transaction request, and alert an operator of the transaction system 150 that manual assistance is required to determine the appropriate access protocol to use for this newly identified bank.

Having determined the purchaser's bank and the access protocol required to gain access to the bank's online system, the processing system 350 determines the information required from the purchaser 120. If the transaction system 150 includes a purchaser database 320, and if the current purchaser 120 has a record in the purchaser database 320, the processing system 350 accesses the purchaser's record and maps the purchaser information to the access protocol. For the purposes of this disclosure the term purchaser information refers to either the information that is obtained from the purchaser 120 or from the purchaser database 320.

Preferably, even if the purchaser's information in the purchaser database 320 is sufficiently complete to provide all of the information required by the access protocol, the processing system 350 is configured to require the purchaser to provide at least one of the elements of the access protocol, such as the userID, password, or access code, so that only someone with this particular information will be able to access the bank information for the identified purchaser. One of skill in the art will recognize that other security measures may be used in addition to, or instead of, requiring the user to enter an element of the access protocol. For example, the processing system 350 may require the user to provide a password in order to enable the processing system 350 to access the purchaser's record in the purchaser database 320.

If there is no purchaser database 320, or if the current purchaser does not have a record in the purchaser database 320, the processing system 350 is configured to obtain sufficient purchaser information to provide a mapping of this information to the access protocol of the purchaser's bank. If the transaction system includes a purchaser database 320, a record may be created for the current purchaser in the database 320, if the current purchaser authorizes such a record.

In accordance with the access protocol for the purchaser's bank, the processing system 350 will submit the appropriate information to gain access to some or all of the bank records associated with the purchaser. In particular, the processing system 350 will obtain an identification of each of the purchaser's accounts with the bank from which a funds transfer can be effected, and an identification of the balance available for funds transfer from each of these accounts.

The processing system 350 communicates the balance associated with each of the purchaser's accounts that have sufficient funds to cover the purchase amount in the transaction request to the purchaser 120, and provides the purchaser 120 with the option to select the particular account from which the purchase amount will be transferred. The processing system 350 may also communicate the balance associated with accounts with insufficient funds, but may not permit a funds transfer request from these accounts. Preferably, these accounts are presented to the purchaser in a format that distinguishes these accounts from the accounts with sufficient funds, such as in a ‘greyed’ format, and which does not allow for the user's selection of any of these accounts.

Assuming that the purchaser has decided to continue with the transaction by having identified a select account from which to debit the purchase amount, the processing system 350 generates a funds transfer request to effect the debit of this amount from the purchaser's selected account and a corresponding credit to the account associated with the vendor. This funds transfer request may be of any form that will effect this debiting and crediting.

In a straightforward embodiment of this invention, a funds transfer system, such as the Automated Clearing House (ACH), may be used. In such an embodiment, the funds transfer request comprises an ACH payment message that identifies the provider of the transaction system as the ‘originator’ of an ACH debit from the purchaser's selected account and an ACH credit to the vendor's identified account. This ACH payment message is transmitted to the ACH network, which effects the requested debit and credit, typically within 1-3 days.

Of particular note, the use of the ACH network enables the transaction system 150 to effect the requested transaction between any two parties having ACH-recognizable accounts, which in the United States are accounts in virtually all banks, credit unions, brokerages, and the like. Additionally, because the transaction system 150 effects the transfer of funds via the ACH network, and does not receive or disburse any funds directly, is not required to operate a clearing or holding account, thereby substantially reducing the overhead associated with the requested transaction.

In a more customized embodiment of this invention, select banks may provide features that enable the transaction system 150 to use the bank's resources directly to effect the funds transfer. In such an embodiment, for example, upon receipt of a funds transfer request that identifies the purchaser's select account, the purchase amount, and the vendor's identified account, the bank immediately debits the purchaser's select account for the purchase amount, deposits this purchase amount in a holding account, and executes a transfer of the purchase amount from the holding account to the vendor's identified account.

In this customized embodiment, because the transaction system is effecting an immediate debit to the purchaser's account, the bank may require a higher level of security and validation compared to the level required for reading the balances available in each of the user's accounts. This additional security may require the submission of the purchaser's password that allows full control of the purchaser's accounts in lieu of the purchaser's access code that provides read-only access to the purchaser's accounts. Alternatively, or additionally, this incremental security may require an authentication process to verify that the system submitting the funds transfer request is, in fact, the transaction system 150 that the bank has authorized to submit such transfer requests.

The bank may use the ACH network to effect the transfer to the vendor's identified account, but an advantage of using the bank's resources to effect this transfer is that the funds are immediately debited from the purchaser's account, effectively guaranteeing payment to the vendor. Additionally, this embodiment provides the purchaser with an accurate balance for any further transaction, as compared to balances that do not reflect the debits via the ACH network for 1-3 days.

A further advantage of using the bank's resources directly is that the ACH credit records will only indicate an identification of the bank's holding account, without an identification of the purchaser's account, thereby isolating the purchaser's account information from the vendor.

Upon completion of the funds transfer request process, using either of the above techniques, or other funds transfer processes, the processing system 350 prepares a transaction report for transmission to the vendor system 130. This transaction report will typically confirm that a funds transfer to the vendor's identified account for the purchase amount has been authorized and initiated, and, in the case that the purchaser's account has been directly debited, may include a statement assuring the vendor that the funds are ‘guaranteed’ to be credited to the vendor's identified account. Preferably, information regarding the purchaser's bank account is not included in this transaction report.

Upon sending the transaction report, the processing system 350 concludes the transaction authorization process and relinquishes control to the vending system 130. Completion of the transaction process may happen with this transaction report or be confirmed (or not) at a future point in time via a new report.

One of skill in the art will recognize that the processing system 350 may perform other functions in addition to those cited above. For example, during the interactions with the purchaser's bank, the processing system 350 may generate messages for the purchaser, such as “Payment in progress”, “Payment completed”, “Thank you for using our service”, and the like. In like manner, if problems occur during the transaction process, such as an inability to access the purchaser's accounts, or an inability to submit the funds transfer request, the processing system 350 will take remedial action, such as re-attempting the failed task, interacting with the user to obtain additional or alternative information, and the like. Similarly, the processing system 350 may notify the purchaser of the balance that will be remaining after debiting the selected account for the purchase amount, may provide a receipt to the purchaser, confirming that the purchase amount was transferred to the vendor, and so on.

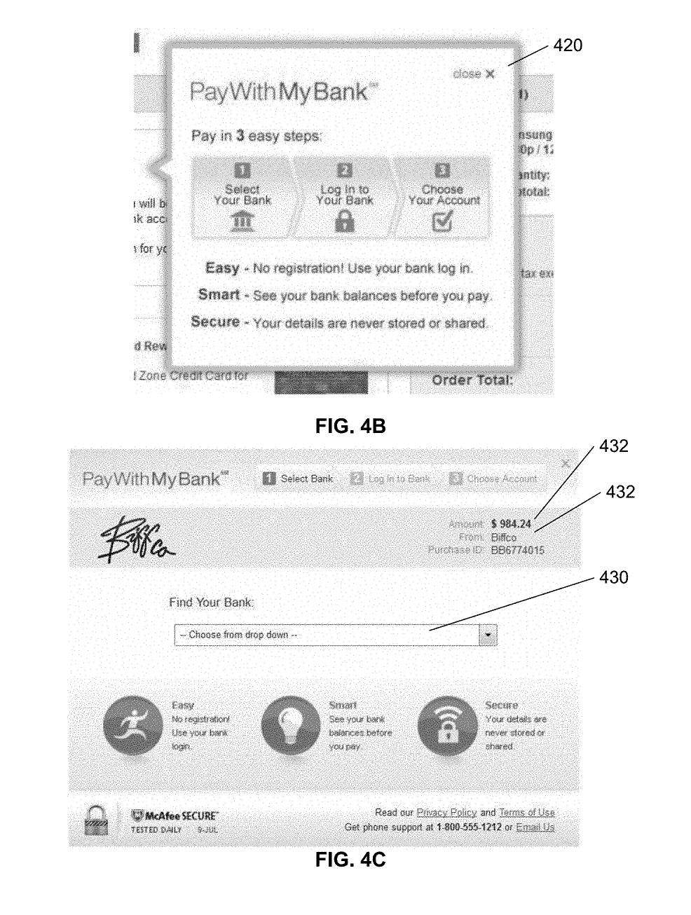

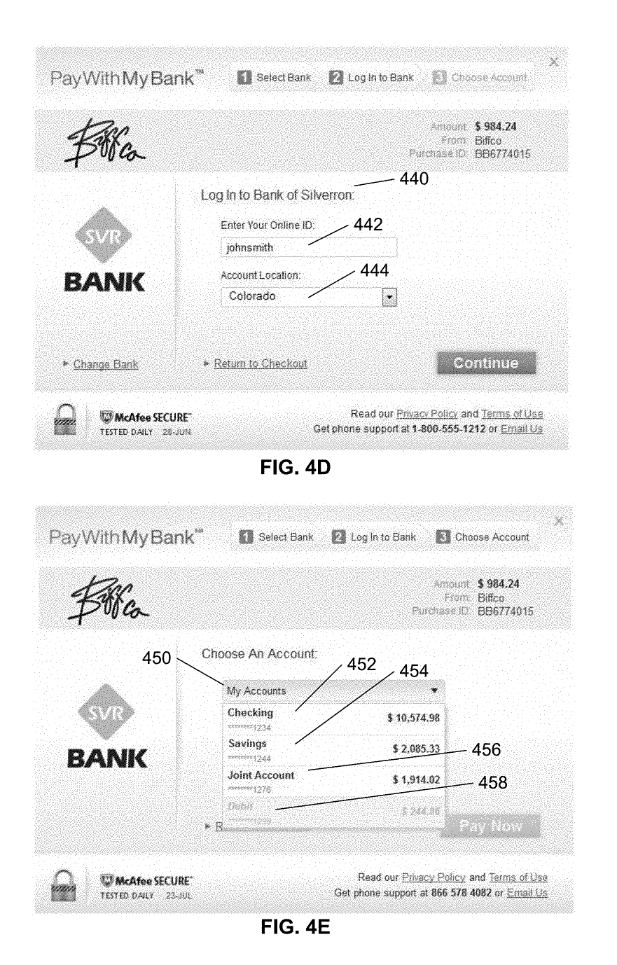

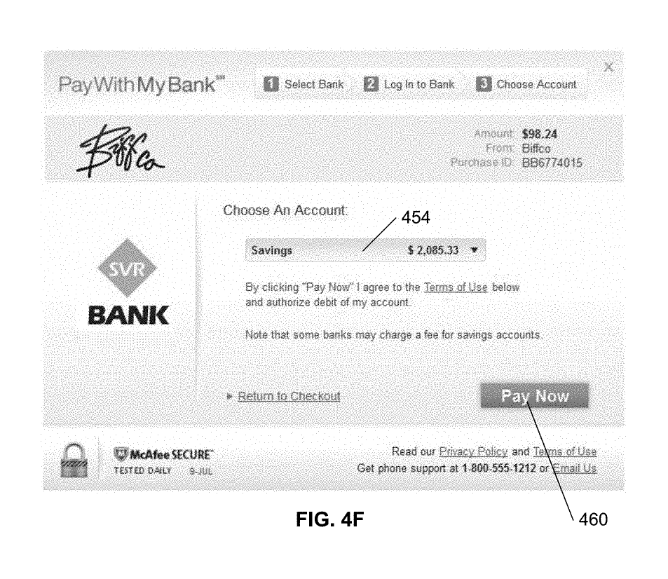

FIGS. 4A-4F illustrate screen-shots of an example user interface for using an example embodiment of the transaction system 150. These example screen-shots are of an embodiment of this invention called “PayWithMyBank”, provided by eWise Systems USA Inc. of Redwood City, Calif.

FIG. 4A illustrates an example vendor webpage for allowing the purchaser to select “PayWithMyBank” 410 to effect the purchase transaction, as an alternative to a credit card 412 transaction or a PayPal 414 transaction.

FIG. 4B illustrates an example ‘splash page’ 420 provided by the “PayWithMyBank” transaction system, identifying the steps involved in the use of this transaction system.

FIG. 4C illustrates a user interface for identifying the purchaser's bank. In this example, the user may select from among banks that are listed via a ‘drop down’ box 430. Within this list (not illustrated) is a “My Bank isn't Listed” selection, which will initiate other processes for finding the user's bank, including the entry of the bank's routing transit number (RTN), the bank's name and address, and so on.

Of particular note, each of FIGS. 4C-4F include an identification of the vendor (“BiffCo”) 432 and the purchase amount ($984.24) 434 for the purchaser's convenience.

FIG. 4D illustrates a user interface for obtaining access information for the purchaser's accounts at the identified bank (“Bank of Silverron”) 440. In this example, the “Bank of Silverron” 440 may only require an “Online ID” 442 and an “Account Location” 444 to enable viewing of the purchaser's accounts and balances at this bank (e.g. read-only access).

Alternatively, FIG. 4D may illustrate a first page of a multipage user interface (not illustrated), wherein subsequent pages are displayed based on the bank's response to the submitted information (“johnsmith” and “Colorado”). For example, the bank's response may be that the Online ID is not recognized, and the next page will be an appropriate notification with a request to re-enter the Online ID. The bank's response may alternatively be “Enter Password”, indicating that the Online ID and Account Location were accepted, and the next page from the transaction system will be a request for the purchaser's password.

FIG. 4E illustrates the presentation of the purchaser's accounts 450 and the balance in each account to the purchaser by the transaction system. In this example, each of the accounts “Checking” 452, “Savings” 454, and “Joint Account” 456 has sufficient funds to cover the purchase amount, but the account “Debit” 458 does not. The Debit account 458 is ‘greyed’ and is not available for selection by the purchaser for transferring the purchase amount.

FIG. 4F illustrates that the purchaser has identified “Savings” 454 as the select account for debiting the purchase amount. When the purchaser selects the “Pay Now” button 460, the funds transfer process commences.

In this example, at FIG. 4E, the accounts are identified by their “names”, and the particular account numbers are only identified by the last four digits of the account numbers. Even with an identification of the bank that provides the account, the “last N” digits of an account at the bank is not likely to provide a unique identifier of the purchaser's account. In the event of such a situation, the processing system 350 may be configured to provide another page that prompts the user for the full account number for the selected account. In a preferred embodiment of this invention, on the other hand, the processing system 350 may be configured to explore other means for obtaining the purchaser's information, such as accessing a copy of the latest monthly ‘statement’ for the “Savings” account and using context and text recognition to determine the full account number.

One of skill in the art will recognize that other embodiments and features may be included within the general framework provided by this disclosure. For example, the process flow of FIG. 2 provides the paradigm of a ‘hand off’ process, wherein the vendor system formulates a purchase request and hands off the purchaser to the transaction system, and the transaction system obtains the information necessary to effect a funds transfer, then hands the purchaser off back to the vendor system. One of skill in the art will recognize that a more integrated process may be provided, wherein for example, the transaction system performs tasks that serve to ease the purchaser's interaction with both the vendor system and the transaction system, and serve to provide more than a simple ‘transaction verified’ response to the vendor's transaction request.

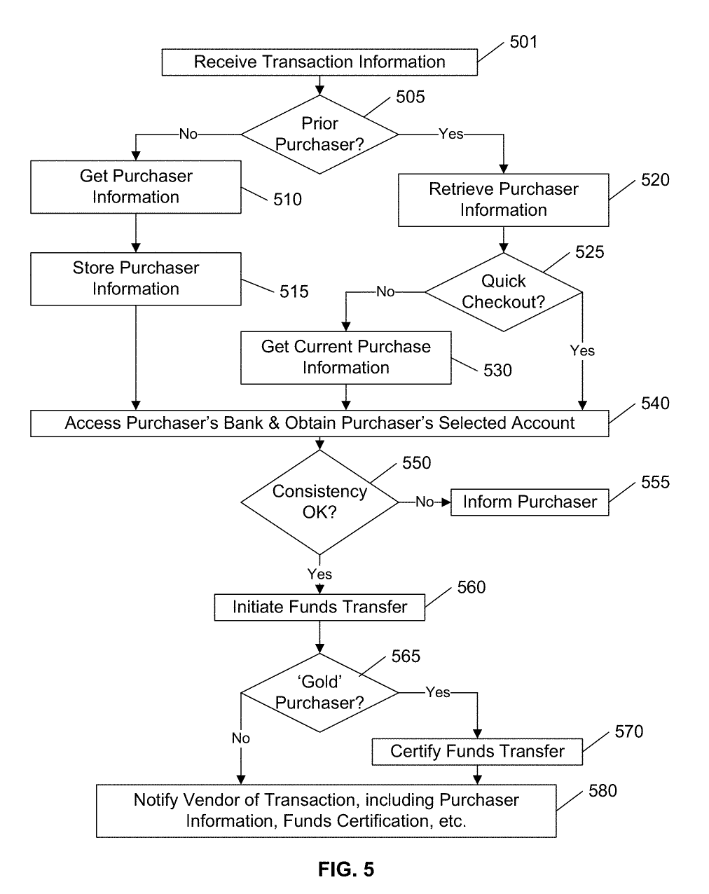

FIG. 5 illustrates an example flow diagram that illustrates some of the interactions and tasks that the transaction system may be configured to perform.

At 501, transaction information is received at the transaction system from the vendor system; this information may include, for example, an identifier of the vendor, the purchase amount, and the link used for communicating with the purchaser. This information may also include an identifier of the purchaser; but if not, the transaction system may prompt the purchaser for such an identifier, for example, as a log-in prompt.

In this example embodiment, the transaction system maintains a database of purchaser information. At 505, the system determines, based on the identifier of the purchaser, whether the current purchaser is a prior purchaser or a new purchaser. If the purchaser is not a prior purchaser, the system obtains the purchaser information (name, bank account identifier, etc.), at 510, and stores it in the purchaser database, at 515.

If, at 505, the purchaser is identified as a prior purchaser, the purchaser's information is retrieved from the purchaser database, at 520. Preferably, the system obtains verification information, such as a pin or password, and accesses the purchaser's information only if the verification information corresponds to the identified purchaser's verification information.

The stored purchaser information may include the information previously obtained from the user, as well as information obtained during the prior transactions with this purchaser. For example, the bank access information and protocol may be stored for this purchaser, as well as the bank's record of the purchaser's mailing address, and other details. Preferably, at least one key item required to access the purchaser's bank account, such as the PIN, is not stored in the purchaser database. In this manner, if the database is compromised, or another person gains access to the transaction system posing as the purchaser, access to the purchaser's bank account will not be obtained without this key item.

At 525, the purchaser has the option of a “quick checkout”, wherein the transaction system uses the purchaser's information for accessing the purchaser's bank accounts, and other ‘default’ processes. For example, the purchaser may have identified a particular bank account to be used as the default for all transactions, avoiding the need to expressly select the account during each transaction. In like manner, in an embodiment that facilitates the purchaser's interaction with the vendor system, the purchaser information may be used to provide a default ‘ship-to’ address that is communicated to the vendor system upon completion of the transaction.

If, at 525, the purchaser does not select “quick checkout”, the transaction system will obtain the required information for this transaction directly from the purchaser, at 530. For example, the purchaser may wish to select a different bank account in lieu of the default bank account, or may specify a different ship-to address, and so on. Optionally, the user may replace the default choices with these new choices.

With the purchaser information obtained from either block 510, 520, or 530, the transaction system proceeds to access the purchaser's bank, using the procedures detailed above to obtain a selection of one of the purchaser's bank accounts with sufficient funds for use in this transaction. The transaction system may also obtain other information from the purchaser's bank, such as the user's name, address, email address, telephone number, and other available personal information.

At 550, a “consistency” check may be performed. In an example embodiment, the transaction system may check to assure that the ship-to name and address to be used by the vendor correspond to a name and address that is associated with this purchaser. If the purchaser is a new purchaser, the check may be that the ship-to name and address match the purchaser's name and address in the bank's records; if the purchaser is a prior purchaser, a method may be provided after the first transaction for the purchaser to securely add authorized ship-to names and addresses. One of skill in the art will recognize that other consistency checks may also be applied, such as checking that the purchaser's given e-mail address or contact telephone number match the e-mail address or contact number in the bank's records.

If, at 550, the consistency check indicates a problem, the purchaser is notified, at 555, and the transaction is terminated. Preferably, this notification is also communicated to the purchaser using a contact means, such as a text or e-mail message to a contact address associated with the purchaser. In this manner, if an impostor has attempted to make a purchase using the purchaser's account information, the purchaser is notified.

If, at 550, the purchase information is found to be consistent, the requested funds transfer is initiated, at 560, using the techniques detailed above. As noted, the initiation of the transfer may effect an immediate transfer of funds, or it may produce a funds transfer request that is processed at a later time.

After the funds transfer is initiated, an optional “Gold Purchaser” check 565 is performed. If the current purchaser is deemed to be a Gold Purchaser, the provider of the transaction system ‘certifies’ the funds transfer to the vendor, effectively guaranteeing that the funds have or will be transferred. The vendor, may, for example, provide expedited delivery for purchases that have been so certified.

The Gold Purchaser check may use any of a variety of criteria to certify the funds transfer. If, for example, the interaction with the purchaser's bank results in an immediate funds transfer, rather than a future transfer, the funds transfer can obviously be certified, at no risk to the provider of the transaction system. Certifying a future transfer, however, incurs the risk that the purchaser may take action to prevent the transfer. For example, the user may contact the bank and place a hold on the transfer, or the user may otherwise transfer funds out of the selected account, causing the transaction system's transfer to fail.

If the provider of the transaction system is willing to accept some risk, in return for repeat-customer satisfaction and/or incremental compensation, the transaction system may be configured to evaluate the purchaser's records at their bank and/or in the transaction system to determine a level of confidence that the purchaser will not take action to prevent the future transfer or that the purchaser's bank account balance will be sufficient to cover the future transfer. If the purchaser has a long history of not missing/failing scheduled transfers, the likelihood of the user interfering with the current transfer is likely to be low.

In like manner, if the transfer amount is below a particular threshold, and the purchaser has at least some prior history, at the purchaser's bank or with the transaction system, of not missing/failing scheduled transfers, the likelihood of a failure of the scheduled transfer is also likely to be low. In some embodiments of the transaction system, the threshold amount may be determined dynamically. For example, each successful transfer may effect an increase in the threshold for the purchaser, or the average balance in the user's selected bank account may be used to set the threshold for each purchase. One of skill in the art will recognize that other criteria for certifying the funds transfer based on characteristics associated with the purchaser may be used as well.

At 580, the results of the transaction are communicated to the vendor. In this example embodiment, in addition to acknowledging that the funds transfer has been initiated, the transaction system may also provide some of ancillary information obtained from the purchaser, the purchaser's records in the transaction system's database, or the purchaser's records at the purchaser's bank, such as the purchaser's name and/or ship-to address and/or phone number and/or email address, thereby avoiding having the user re-supply this information to the vendor.

In addition to potentially certifying the funds transfer, the transaction system may also provide a score, or rating, for each purchaser, based on the characteristics associated with the purchaser, such as the history of successful transactions, and so on. The vendor may use such a rating to offer potential “frequent purchasers” special offers or other incentives.

One of skill in the art will recognize that other features and options may be provided, and that the above features may be enhanced in any number of ways. For example, the transaction system may be configured to obtain and register an identifier of the purchaser's access device, such as a computer's MAC address, and may modify the above procedures based on whether a prior purchaser is communicating via a registered access device. The criteria used in the consistency check or golden purchaser check, for example, may be different, depending upon whether the purchaser is using a registered access device. In like manner, the aforementioned criteria may also be dependent upon the purchase amount, the particular vendor's standards, the purchaser's history, and so on.

Similarly, the interaction with the transaction system may be customized based on the particular device that the purchaser is using for the current transaction. The transaction system may optionally allow access to the purchaser's information using a username and password or PIN code, a mobile number, mobile device ID, RF ID or NFC ID or other means of verifying that the true purchaser is accessing the system. Assuming that the purchaser's information, including selected defaults, includes the information necessary to access the purchaser's select account (as noted above, preferably lacking a key item), when the purchaser gains access to the transaction system, the transaction system is able to satisfy the funds transfer request with minimal further interactions with the purchaser (e.g. obtaining the key item).

Although the process has been described as a ‘one pass’ operation, wherein the funds request is received and processed, and the funds transfer is initiated, one of skill in the art will recognize that other scenarios may be provided as well. For example, there may be a substantial time delay before the vendor can ship the product, and the vendor may want to postpone the transfer of funds until the product is shipped. In this case, the vendor may initially desire a ‘promise to pay’ from the transaction system, after the transaction system verifies that the purchaser's account has sufficient funds to cover the purchase. Thereafter, the vendor or the purchaser may contact the transaction system to initiate the actual transfer. Optionally, if an appropriate interaction with the purchaser's bank is established, the purchase amount may be made unavailable to the purchaser when the initial ‘promise to pay’ is generated.

In like manner, the vendor may offer the purchaser a recurring payment option. In this case, the transaction system may initiate the initial funds transfer request for a given amount, and initiate funds transfer requests in the future based on billing rules agreed upon up-front between the purchaser and the vendor. The transaction system will receive these requests, verify their compliance with the agreed billing rules, and initiate the fund transfers. For example, such billing rules may be to initiate a funds transfer of a fixed given amount at the end of each billing cycle for a limited, or unlimited, number of billing cycles. The rules may also include initiating a funds transfer of a fixed or variable amount each time a time-independent trigger event takes place (for instance, a prepaid balance gets depleted and must be replenished). These programmed transfers may be performed without the purchaser's further involvement, perhaps with a reminder message to the purchaser before each transfer. Alternatively, the transaction system may send a message to the purchaser and wait for the purchaser's acknowledgement before each transfer.

One of skill in the art may recognize that the particular techniques for supporting recurring payments may vary, depending upon the particular embodiment of the transaction system, the particular vendor, and so on. In some embodiments, the transaction system may automatically effect the recurring transfers based on the agreed billing rules. In other embodiments, the vendor may be required to initiate each subsequent request for the recurring transfers. In this embodiment, the transaction system will verify that the subsequent request from the vendor is consistent with the agreed upon billing rules, and, if so, will initiate the transfer process. As noted above, these transfers may be made without the purchaser's direct involvement, or may be made only after receiving the purchaser's acknowledgement for each transfer.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the transaction request is presented herein as a funds transfer from the purchaser to the vendor, the system may be used for credit transfers as well. In this case, the purchaser may identify the account to which the funds should be transferred from the vendor's account, and the funds transfer will be from the vendor's account to the purchaser's selected account.

In like manner, although the disclosed system is designed to initiate funds transfers in response to a transaction request from a vendor, it may be configured to operate in other modes as well. For example, having the means to effect funds transfers, the transaction system may be enhanced to include conventional on-line banking tasks, such as purchaser-initiated bill paying, funds transfers between the purchaser's accounts, and so on.

Similarly, although the invention is presented using the paradigm of a purchaser having multiple accounts at the same bank, the location of the user's accounts is substantially immaterial to the processes disclosed. Accordingly, the purchaser's records at the transaction system may include the purchaser's accounts at multiple banks. In this case, with regard to on-line banking tasks, the transaction system can be enhanced to allow the purchaser to view all of these accounts, and, for example, pay bills from any of these accounts without having to change contexts from bank to bank.

These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) no specific sequence of acts is intended to be required unless specifically indicated;

d) several “means” may be represented by the same item or hardware or software implemented structure or function;

e) each of the disclosed elements may be comprised of a feasible combination of hardware portions (e.g., including discrete and integrated electronic circuitry) and software portions (e.g., computer programming).

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise; and

j) the term “plurality of” an element includes two or more of the claimed element, and does not imply any particular range of number of elements; that is, a plurality of elements can be as few as two elements, and can include an immeasurable number of elements.

We claim:

1. A method of protecting disclosure of a customer's account information to a vendor, comprising:
at a transaction server that is independent of the customer and the vendor:
receiving a transaction request that identifies the vendor, a vendor account, and a transaction amount;
receiving, from the customer, credentials to access a banking system;
accessing the banking system using the customer's credentials to obtain the customer's account information, including identification of a customer account at the banking system;
executing a funds transfer of the transaction amount from the customer account to the vendor account; and
notifying the vendor that the transfer has been executed, without disclosing the customer account information to the vendor.

2. The method of claim 1, wherein the transaction server obtains the customer's credentials by creating a user interface that emulates the interface of the banking system.

3. The method of claim 1, including, by the transaction server: receiving financial information related to the customer account from the on-line banking application; communicating the financial information to the customer; and receiving further information from the customer; wherein the executing of the funds transfer is dependent upon the further information from the customer.

4. The method of claim 1, including, by the transaction server: receiving financial information related to the customer account from the banking system; wherein the executing of the funds transfer is dependent upon the financial information from the banking system.

5. The method of claim 1, wherein the transaction request is communicated to the transaction server by a system associated with the vendor.

6. The method of claim 1, wherein the banking system is accessed via an on-line banking application.

7. The method of claim 1, wherein the banking system is accessed via an application program interface (API).

8. A non-transitory computer-readable medium that comprises a program that, when executed by a processing system, causes the processing system to prevent disclosure of a customer's account information to a vendor, by causing the processing system to:
receive a transaction request that identifies the vendor, a vendor account, and a transaction amount;
receive, from the customer, credentials to access a banking system;
access the banking system using the customer's credentials to obtain the customer's account information, including an identification of a customer account at the banking system;
execute a funds transfer of the transaction amount from the customer account to the vendor account; and
notify the vendor that the transfer has been executed, without disclosing the customer account information to the vendor.

9. The medium of claim 8, wherein the program causes the processing system to obtain the customer's credentials by providing a user interface that emulates the interface of an on-line banking application of the banking system.

10. The medium of claim 8, wherein the program causes the processing system to: receive financial information related to the customer account from the banking system; communicate the financial information to the customer; and receive further information from the customer; wherein the executing of the funds transfer is dependent upon the further information from the customer.

11. The medium of claim 8, wherein the program causes the processing system to receive financial information related to the customer account from the banking system; wherein the executing of the funds transfer is dependent upon the financial information from the banking system.

12. The medium of claim 8, wherein the transaction request is received from a system associated with the vendor.

13. The medium of claim 8, wherein the program causes the processing system to access the banking system via an on-line banking application.

14. The medium of claim 8, wherein the program causes the processing system to access the banking system via an application program interface (API).
